(19) United States
(12) Patent Application Publication
(10) Pub. No.: US 2025/0190249 A1
(43) Pub. Date: Jun. 12, 2025

(54) RESOURCE SCHEDULING METHOD AND APPARATUS

(71) Applicant: CLOUD INTELLIGENCE ASSETS HOLDING (SINGAPORE) PRIVATE LIMITED, Singapore (SG)

(72) Inventor: Kenan LIU, Hangzhou (CN)

(21) Appl. No.: 18/840,848

(22) PCT Filed: Feb. 3, 2023
(86) PCT No.: PCT/CN2023/074447

§ 371 Date: Aug. 22, 2024

(30) Foreign Application Priority Data
Feb. 23, 2022 (CN) 202210171049.8

(51) Int. Cl. G06F 9/48; G06F 9/455

(52) U.S. Cl. CPC G06F 9/4881; G06F 9/45558

(57) ABSTRACT

Provided are a resource scheduling method and apparatus, where the resource scheduling method is applied to a physical machine, including: a kernel scheduler of the physical machine determining, based on a preset resource scheduling cycle, a quantity of virtual CPUs of a virtual machine running in a run queue of a target physical CPU; determining, based on the quantity of the virtual CPUs, a switch state of a non-exit function of a virtual CPU, and determining, based on the switch state, a target scheduling strategy of the virtual CPU; regulating, based on the target scheduling strategy, a running state of the virtual CPU of the virtual machine, thereby achieving timely shutdown of the non-exit function(s) of the virtual CPU(s), ensuring that unnecessary physical CPU resources are not consumed, as well as enabling the non-exit function(s) of the virtual CPU(s) to improve application performance of the virtual CPU(s).

### CROSS-REFERENCE TO RELATED APPLICATIONS

The present application is a National Stage of International Application No. PCT/CN2023/074447, filed on Feb. 3, 2023, which claims priority to Chinese Patent Application No. 202210171049.8, filed on Feb. 23, 2022 to the China National Intellectual Property Administration and entitled “RESOURCE SCHEDULING METHOD AND APPARATUS”. These applications are incorporated into the present application by reference in their entireties.

### TECHNICAL FIELD

Embodiments of the present specification relate to the field of computer technology and, in particular, to a resource scheduling method.

### BACKGROUND

Due to the introduction of virtualization technology, a layer of virtual machine monitor (Virtual Machine Monitor, VM) has been added between the operating system and the hardware, which is responsible for managing hardware resources of the computer system. In virtualization scenarios, when a virtual central processing unit (Virtual Central Processing Unit, VCPU) executes an HLT (exit instruction) operation, it triggers exit of a virtual machine (Virtual Machine), this operation also consumes certain computing resource(s) and occupies physical CPU resource(s). If the virtual machine is frequently held in entered and exit states, the virtual CPU would consume a large amount of physical CPU resources, resulting in a decrease in the application performance of the virtual CPU of the virtual machine in a virtualized environment.

### SUMMARY

In view of this, embodiments of the present specification provide a resource scheduling method. One or more embodiments of the present specification also relate to a resource scheduling apparatus, a computing device, a computer readable storage medium, and a computer program, in order to address technical deficiencies in prior art.

According to a first aspect of the embodiments of the present specification, a resource scheduling method is provided, which is applied to a physical machine. The method includes:
determining, by a kernel scheduler of the physical machine, based on a preset resource scheduling cycle, a quantity of virtual CPUs of a virtual machine running in a run queue of a target physical CPU;
determining, based on the quantity of the virtual CPUs, a switch state of a non-exit function of a virtual CPU, and determining, based on the switch state, a target scheduling strategy of the virtual CPU;
regulating, based on the target scheduling strategy, a running state of the virtual CPU of the virtual machine.

According to a second aspect of the embodiments of the present specification, a resource scheduling apparatus is provided, which is applied to a physical machine. The apparatus includes:
a kernel scheduler of the physical machine, configured to determine, based on a preset resource scheduling cycle, a quantity of virtual CPUs of a virtual machine running in a run queue of a target physical CPU;
where the kernel scheduler of the physical machine is further configured to determine, based on the quantity of the virtual CPUs, a switch state of a non-exit function of a virtual CPU, and determine, based on the switch state, a target scheduling strategy of the virtual CPU;
the kernel scheduler of the physical machine is further configured to regulate, based on the target scheduling strategy, a running state of the virtual CPU of the virtual machine.

According to a third aspect of the embodiments of the present specification, a computing device is provided, and the computing device includes:
a memory and a processor;
where the memory is configured to store computer executable instructions, the processor is configured to execute the computer executable instructions, when the computer executable instructions are executed by the processor, steps of the resource scheduling method mentioned above are implemented.

According to a fourth aspect of the embodiments of the present specification, a computer readable storage medium is provided, and the computer readable storage medium stores computer executable instructions, when the instructions are executed by a processor, steps of the resource scheduling method mentioned above are implemented.

According to a fifth aspect of the embodiments of the present specification, a computer program is provided, when the computer program is executed in a computer, the computer is enabled to execute steps of the resource scheduling method mentioned above.

The resource scheduling method provided by an embodiment of the present specification is applied to a physical machine. A kernel scheduler of the physical machine determines, based on a preset resource scheduling cycle, a quantity of virtual CPUs of a virtual machine running in a run queue of a target physical CPU; determines, based on the quantity of the virtual CPUs, switch state(s) of non-exit function(s) of the virtual CPU(s), and determines, based on the switch state(s), a target scheduling strategy of the virtual CPU(s); regulates, based on the target scheduling strategy, running state(s) of the virtual CPU(s) of the virtual machine.

Specifically, the kernel scheduler of the physical machine determines, based on the quantity of virtual CPUs of the virtual machine running in the run queue of the target physical CPU, whether the non-exit function(s) of the virtual CPU(s) is/are enabled; and then determines, according to a state of whether the non-exit function(s) is/are enabled, the target scheduling strategy corresponding to the virtual CPU(s), to regulate the running state(s) of the virtual CPU(s); and dynamically regulates, according to the target scheduling strategy, the non-exit function(s) of the virtual CPU(s), thereby achieving timely shutdown of the non-exit function(s) of the virtual CPU(s), ensuring that unnecessary physical CPU resources are not consumed, as well as enabling the non-exit function(s) of the virtual CPU(s) to improve application performance of the virtual CPU(s).

### BRIEF DESCRIPTION OF DRAWINGS

FIG. 1 is a flowchart of a resource scheduling method provided in an embodiment of the present specification.

FIG. 2 is a schematic diagram of a processing procedure of a resource scheduling method provided in an embodiment of the present specification.

FIG. 3 is a schematic structural diagram of a resource scheduling apparatus provided in an embodiment of the present specification.

FIG. 4 is a block diagram of a structure of a computing device provided in an embodiment of the present specification.

### DESCRIPTION OF EMBODIMENTS

Many specific details are elaborated in the following description to fully understand the present specification. However, the present specification can be implemented in many other ways different from those described herein, and those skilled in the art can make similar extensions without violating the purport of the present specification. Therefore, the present specification is not limited by the specific implementation disclosed below.

Terms used in one or more embodiments of the present specification are for the sole purpose of describing specific embodiments and are not intended to limit one or more embodiments of the present specification. The singular forms of “one”, “said”, and “the” used in one or more embodiments of the present specification and the appended claims are also intended to include the plural forms, unless the context clearly indicates other meanings. It should also be understood that the terms “and/or” used in one or more embodiments of the present specification refer to and include any or all possible combinations related to one or more listed items.

It should be understood that although various information may be described using terms such as first, second, etc. in one or more embodiments of the present specification, such information should not be limited to these terms. These terms are only used to distinguish information of the same type from each other. For example, without departing from the scope of one or more embodiments of the present specification, the first may also be referred to as the second, and similarly, the second may also be referred to as the first. Depending on the context, the word “if” used herein can be interpreted as “when” or “at the time that . . . ” or “in response to determining . . . ”.

Firstly, explanation will be made to the terminologies involved in one or more embodiments of the present specification.

Virtual machine (Virtual Machine): refers to a complete computer system with a complete hardware system functionality simulated through software and running in a completely isolated environment.

Virtual machine monitor (Virtual Machine Monitor, VMM): a virtualization abstraction layer that runs between an underlying physical server and an operating system, allowing multiple operating systems and applications to share hardware.

CPU scheduler (CPU Scheduler): a scheduling algorithm for processes/threads in Linux, which shares CPU time between processes/threads. One important goal of a scheduler is to effectively allocate CPU time slices while providing a good user experience. Linux adopts different scheduling strategies according to different classifications of processes. For real-time processes, FIFO or Round Robin scheduling strategies are adopted. For ordinary processes, it is necessary to distinguish between interactive and batch processing. Traditional Linux schedulers increase priorities of interactive applications, allowing them to be scheduled faster.

Run queue (run queue) of a CPU: in Linux systems, each CPU corresponds to a run queue structure instance (struct rq), processes in a ready state are organized together.

Virtual CPU (VCPU): a CPU simulated using virtual machine technology. In virtualization platforms, multiple virtual CPUs used by a virtual machine (VM) may share underlying physical CPU(s). A virtual machine monitor is responsible for scheduling VCPUs. After a VCPU is scheduled to obtain usage right of a physical CPU, the VM operating system running based on this VCPU can schedule various threads/processes within the VM. That is, in the virtual machine operating system, various threads/processes multiplex the virtual CPU in a time division manner, while respective virtual CPUs multiplex the physical CPU in a time division manner.

HLT: this is the first generation idle instruction, introduced in the 486DX era. Firstly, HLT instruction can only be executed at the privilege level of Ring0, and the execution effect is that a CPU enters a C1/C1E state (refer to ACPI standard). APIC/BUS/CACHE operates as usual, and whenever an interrupt occurs, the CPU immediately exits the idle state.

HTL non-exit: refers to the state where the virtual CPU does not perform an exit operation after the virtual machine receiving an HTL instruction, enabling the current virtual CPU to be held in a non-exit state.

Virtualization is a cloud technology where multiple virtual machines may run simultaneously on a physical machine, resulting in the possibility of one or more virtual CPUs running on a physical CPU, virtual CPUs rely on schedulers for scheduling and multiplex the underlying physical CPU resource(s) in a time division manner. VT-X is an instruction set that utilizes virtualization technology and is a hardware virtualization technology for CPUs. VT can simultaneously improve the virtualization efficiency and the security of virtual machines. Among them, HLT non-exit is an optimization solution aimed at improving the performance of virtual machines in virtualization scenarios. The virtual machines are made to no longer generate VM EXIT when executing HLT instruction, so as to reduce the overhead introduced at the virtualization level and eliminate the delay caused by scheduling an idle VCPU on a physical machine, and effectively improve the performance of virtual machines.

When the HLT non-exit, as a solution to optimize the performance of the virtual machine, is enabled, the virtual CPU will remain in a runnable state as it will no longer be at VM EXIT. At this time, the virtual CPU will try to seize the physical CPU resource(s) as much as possible, which is often suitable for scenarios where the virtual CPU can monopolize the physical CPU. If these exclusive virtual CPUs can enable HLT non-exit, the performance will be improved to some extent compared to the performance before the HLT non-exit is enabled. When multiple virtual CPUs compete for resources on a same physical CPU, the HLT non-exit function will actually have side effects. Because all competing virtual CPUs are in the runnable state, even if the virtual CPU is completely idle, it will try to seize the time of the physical CPU as much as possible, resulting in unnecessary competition. Therefore, HLT exit cannot bring good effects in shared scenarios where the quantity of virtual CPUs is greater than that of physical CPUs.

In order to solve the unnecessary consumption of computing resource(s) caused by exit operations of virtual machines in virtualization scenarios, an embodiment of the present specification provides a scheduling system and a technology based on HLT non-exit, and achieving a scheduling strategy for a virtual CPU with dynamic HLT exit. When the HLT of the virtual machine is dynamically switched to exit or not exit according to whether the virtual CPU monopolizes the underlying physical CPU resource(s), and when it is detected that the virtual CPU monopolizes the physical CPU, its HLT non-exit function is enabled, to get performance improvement; when it is detected that the virtual CPU does not monopolize the physical CPU, its HLT non-exit function is disabled. The resource scheduling method provided in the embodiments of the present specification can effectively improve the performance of exclusive virtual CPUs in shared scenarios, and ensure that non-exclusive virtual CPUs do not consume unnecessary physical CPU resource(s).

It should be noted that an embodiment of the present specification also provides an optimization solution for HLT-Polling (when vm-exit occurs with respect to the exit instruction of the virtual machine, the physical machine continues polling for a period of time for reducing latency). When the virtual CPU generates a VM EXIT, the virtual CPU will not be directly set to idle, but will keep POLLING (polling) for a period of time in a kernel mode to check whether there is a new request, and if so, continue to process the request directly, which can eliminate the overhead introduced by once scheduling. When there are no requests during the POLLING period, the virtual CPU will be marked as idle and the physical CPU will be given to other virtual CPUs in need. However, the HLT-POLLING solution depends on whether there is load inside the virtual machine, rather than whether there are other virtual CPUs on the physical CPU. When multiple virtual CPUs compete for underlying CPU resources, this solution often results in impaired performance of all virtual CPUs, making it unsuitable for shared scenarios. HLT-Polling will give VCPU a period of time to poll whether there is a request; if there are no requests, the CPU resources during this period of time will be completely wasted; moreover, if there is a virtual CPU waiting for CPU resources at this time, a lot of unnecessary computing resources are consumed. However, the scheduling strategy for a virtual CPU with dynamic HLT exit provided by an embodiment of the present specification has certain advantages compared to the HLT-POLLING solution, that is, when there are no other virtual CPUs competing for physical CPU resource(s), the overhead introduced by virtualization and scheduling is effectively eliminated, and the performance of the virtual machine is improved. When there is a virtual CPU participating in competition, the disadvantage of HLT-POLLING will no longer exist, as the HLT non-exit function will be dynamically disabled to prevent physical CPU resource(s) from being wasted by polling, thus avoiding serious competition for virtual CPUs of shared physical CPUs.

Based on this, a resource scheduling method is provided in the present specification. The present specification also relates to a resource scheduling apparatus, a computing device, and a computer readable storage medium, which will be explained in detail in following embodiments.

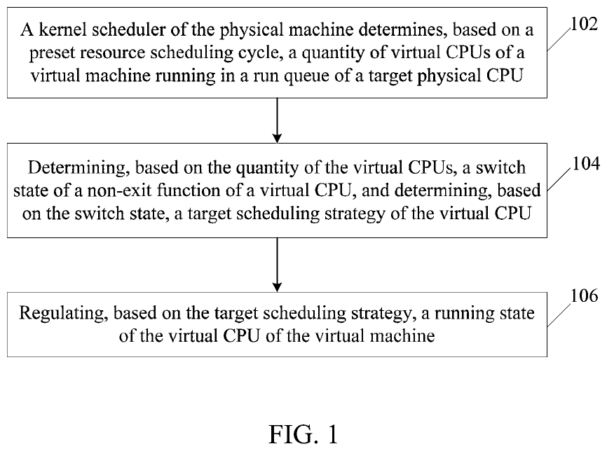

Referring to FIG. 1, FIG. 1 shows a flowchart of a resource scheduling method provided in an embodiment of the present specification, which includes following steps.

It should be noted that the resource scheduling method provided in the embodiment of the present specification is applied to a kernel scheduler in a physical machine, to achieve the scheduling of the virtual CPU occupying the physical CPU resource(s) in the virtual machine.
Step 102: a kernel scheduler of the physical machine determines, based on a preset resource scheduling cycle, a quantity of virtual CPUs of a virtual machine running in a run queue of a target physical CPU.

In practical applications, the kernel scheduler in a physical machine reads the run queue of the current target physical CPU every preset resource scheduling cycle, and checks the quantity of the virtual CPUs running on the target physical CPU, in order to schedule the usage resources of the target physical CPU based on the quantity of the virtual CPUs subsequently.

It should be noted that a quantity of physical CPUs in the resource scheduling method provided by the embodiment of the present specification can be configured as one or multiple. If multiple physical CPUs are configured in a system, a quantity of virtual CPUs running in a run queue of each physical CPU can be determined, thereby achieving the resource scheduling for the virtual CPUs. That is, the dynamic regulation of enabling or disabling of the HLT non-exit function is decided depending on the quantity of virtual CPUs on a single physical CPU. The resource scheduling method provided by the embodiment of the present specification is explained in detail with an example in which a quantity of physical CPUs is 1. Therefore, one physical CPU can run one virtual CPU, or one physical CPU corresponds to multiple (two or more) virtual CPUs. Based on this, the resource scheduling method proposed in this solution does not impose any limitations on the suitable application scenarios. It should be emphasized that in the scenario where the quantity of virtual CPUs in the entire physical machine is greater than the quantity of physical CPUs in the entire physical machine, that is, in a situation that resource competition occurs, the resource scheduling method provided in this embodiment can be used to dynamically regulate the HLT non-exit state, to avoid serious competition for virtual CPUs of shared physical CPUs.

Besides, this solution may also be suitable for application scenarios where the quantity of virtual CPUs in the entire physical machine is less than twice as much as the quantity of physical CPUs in the entire physical machine and greater than the quantity of physical CPUs in the entire physical machine, in order to achieve better resource scheduling decisions. However, the resource scheduling method proposed in the embodiment of the present specification can be suitable in other application scenarios except for the above application scenarios, and there are no specific limitations on the application scenarios.

In order to improve the performance of the virtual CPU, a monitoring layer of the virtual machine first initializes and exposes functional interface(s) that can query and dynamically regulate HLT non-exit to the kernel scheduler, thereby ensuring that the virtual CPU has the non-exit function. Specifically, before the kernel scheduler of the physical machine determines, based on the preset resource scheduling cycle, the quantity of the virtual CPUs running in the run queue of a target physical CPU, the method further includes:
the kernel scheduler of the physical machine scheduling a scheduling interface for the virtual CPU sent by the monitoring layer in the virtual machine; where the scheduling interface is an interface for forwarding a regulating parameter of the running state of the virtual CPU of the virtual machine.

In practical applications, the monitoring layer of the virtual machine performs the initialization operation and exposes the functional interfaces that can query and dynamically regulate HLT non-exit function to the kernel scheduler. And then, when the virtual machine is created, the monitoring layer of the virtual machine ensures, by setting the CPU-BASED-HLT-EXITING bit (switch bit) of the VMCS (control register), that the newly enabled HLT non-exit function of the virtual machine remains in the off-state. Furthermore, the kernel scheduler of the physical machine can call the scheduling interface sent by the monitoring layer of the virtual machine, where the scheduling interface is used to implement the regulation on the CPU-BASED-HLT-EXITING bit (switch bit) and can enable the HLT non-exit function of the virtual machine or disable the HLT non-exit function of the virtual machine. It should be noted that for the enabling or disabling of the HLT non-exit function of the virtual machine, the regulating parameter of the running state of the virtual CPU can be forwarded through the scheduling interface, to achieve to implement the scheduling of the virtual CPU occupying the physical CPU resource(s).

According to the resource scheduling method provided by the embodiment of the present specification, the functional interfaces that can query and dynamically regulate HLT non-exit function are exposed to the kernel scheduler by the virtual machine, to achieve the enabling or disabling of the HLT non-exit function of the virtual machine, in order to subsequently improve application performance of the virtual CPUs by dynamic regulation.
Step 104: determining, based on the quantity of the virtual CPUs, a switch state of a non-exit function of a virtual CPU, and determining, based on the switch state, a target scheduling strategy of the virtual CPU.

The non-exit function of the virtual CPU can be understood as that after the virtual machine receives the HLT instruction, the virtual CPU does not perform the exit operation, so that the current virtual CPU is in a non-exit state; the switch state (on-off state) can be understood as an enabled state (on-state) or disabled state (off-state) for the non-exit function of the virtual CPU; the target scheduling strategy can be understood as a scheduling strategy for the virtual CPU occupying the physical CPU resource(s), the performance improvement of the virtual CPU is achieved according to the scheduling strategy, and unnecessary waste of computing resource(s) is avoided.

In practical applications, in case that the kernel scheduler determines the quantity of virtual CPUs running in a run queue of the target physical CPU, the kernel scheduler can further determine whether the non-exit function of the virtual CPU needs to be enabled or disabled, that is, the non-exit function of the virtual CPU is in the on-state or off-state (the non-exit function of the virtual CPU is the HLT non-exit function); and then determines the target scheduling strategy for the virtual CPU according to different switch states.

It should be noted that the non-exit function for the virtual CPU can be regulated by the kernel scheduler via the switch bit, to achieve that the shared virtual machine can also enjoy the performance improvement brought by HLT non-exit technology in virtualized shared scenarios. The regulation of the non-exit function of the virtual CPU is not limit in the embodiment of the present specification, and other methods of regulating the non-exit function of the virtual CPU can also be used.

In a specific implementation, the kernel scheduler can determine the switch state of the non-exit function of the virtual CPU based on the quantity of virtual CPUs determined in the run queue of the physical CPU, and determine the scheduling strategy for regulating the virtual CPU according to the switch state. There may be two scheduling strategies. The first scheduling strategy can be determined according to the on-state of the non-exit function of the virtual CPU, the second scheduling strategy can be determined according to the off-state of the non-exit function of the virtual CPU. According to the resource scheduling method provided by the embodiment of the present specification, the first scheduling strategy is determined according to the on-state of the non-exit function of the virtual CPU. Specifically, the determining, based on the quantity of the virtual CPUs, the switch state of the non-exit function of the virtual CPU includes:
in case of determining that the quantity of the virtual CPUs running in the run queue is less than or equal to 1, determining that the switch state of the non-exit function of the virtual CPU is an on-state.

In practical applications, in case that the kernel scheduler determines that the quantity of the virtual CPUs running in the run queue is less than or equal to 1, the switch state of the non-exit function of the virtual CPU can be determined as an on-state. In case of determining that the quantity of the virtual CPUs running in the run queue of the physical CPU is 1, it means that only one virtual CPU occupies the physical CPU resource(s), i.e., monopolized usage. So the non-exit function of the virtual CPU can be enabled, so that the virtual CPU, when receiving an exit instruction, still does not exit and can enter into a dormant state, in order to reduce the overhead introduced at the virtualization level, for example, unnecessary overhead caused by the need to re-read the context in a memory in a recovery process after the exit state. Therefore, keeping the virtual CPU that monopolizes the physical CPU in a non-exit state (dormant state) instead of an exit state effectively improves the performance of the virtual machine.

According to the resource scheduling method provided by the embodiment of the present specification, in case of determining that the quantity of the virtual CPUs in the run queue of the physical CPU is less than or equal to 1, the switch state of the non-exit function of the virtual CPU can be determined as an on-state, thus facilitating the subsequent implementation of the non-exit function of the virtual CPU, to improve the performance of the virtual CPU.

Furthermore, after the kernel scheduler determines that the switch state of the non-exit function of the virtual CPU is an on-state, which indicates that the virtual CPU can monopolize the computing resource(s) of the physical CPU. So, the kernel scheduler can further determine the scheduling strategy for the virtual CPU, to achieve the non-exit function of the virtual CPU. Specifically, the determining, based on the switch state, the target scheduling strategy of the virtual CPU includes:
determining a current running state of the virtual CPU, and determining, based on the on-state and the current running state, a first target scheduling strategy of the virtual CPU.

In practical applications, when the virtual machine performs initialization, the monitoring layer of the virtual machine uses the switch bit to make the virtual HLT non-exit function stay in the off-state. That is to say, in the initialization operation, the switch for the non-exit state of the virtual CPU is in the off-state; that is when receiving the HLT exit instruction, the exit function is executed normally. So, when determining the target scheduling strategy, the kernel scheduler first determines the current running state of the virtual CPU running in the run queue of the physical CPU. It should be noted that, following the above example, the quantity of the virtual CPUs in the run queue of the physical CPU is 1, that is, the kernel scheduler simply needs to determine the current running state of one virtual CPU. The current running state may be the on-state of the non-exit function of the virtual CPU, the off-state of the non-exit function of the virtual CPU.

Furthermore, the kernel scheduler further determines a first target scheduling strategy based on the current running state of the virtual CPU and the on-state of the non-exit function which is determined according to the quantity of the virtual CPUs, in order to subsequently regulate the non-exit function of the virtual CPU according to the first target scheduling strategy.

According to the resource scheduling method provided by the embodiment of the present specification, by virtue of determination of the current running state of the virtual CPU in the run queue of the physical CPU, and determination of the first target scheduling strategy of the virtual CPU according to the on-state of the virtual CPU, monopolization of the physical CPU resource(s) by the virtual CPU is achieved, and the performance of the virtual CPU is improved.

In addition, after the kernel scheduler determines the first target scheduling strategy of the virtual CPU according to the quantity of the virtual CPUs running in the run queue of the physical CPU, the kernel scheduler can further determine a corresponding second target strategy according to the off-state of the non-exit function of the virtual CPU. Specifically, the determining, based on the quantity of the virtual CPUs, the switch state of the non-exit function of the virtual CPU includes:
in case of determining that the quantity of the virtual CPUs running in the run queue is greater than 1, determining that the switch state of the non-exit function of the virtual CPU is an off-state.

In practical applications, in case of the kernel scheduler determining that the quantity of the virtual CPUs running in the run queue of the physical CPU is greater than 1, which can be understood as the current run queue of the physical CPU including multiple running virtual CPUs, and the multiple virtual CPUs multiplexing the underlying physical CPU resource(s) in the time division manner. So in this situation, if the non-exit function of the virtual CPU is enabled, it will result in that the virtual CPUs are all in a runnable state due to competition; even if a virtual CPU is idle, it will try to seize time of the physical CPU as much as possible, causing unnecessary competition. Therefore, the exit function of the virtual CPU cannot bring good effects in shared scenarios where the quantity of the virtual CPUs is greater than that of the physical CPUs.

According to the resource scheduling method provided by the embodiment of the present specification, in case of determining that the quantity of the virtual CPUs in the run queue of the physical CPU is greater than 1, the switch state of the non-exit function of the virtual CPU can be determined as the off-state, in order to subsequently avoid seizing of the computing resource(s) of the physical CPU due to the implementation of the non-exit function of the virtual CPUs.

Furthermore, in case of determining that the switch state of the non-exit function of the virtual CPU is the off-state, the kernel scheduler can further determine the second target scheduling strategy of the virtual CPU by determining a current running state of the virtual CPU. Specifically, the determining, based on the switch state, the target scheduling strategy of the virtual CPU includes:
determining the current running state of the virtual CPU, and determining, based on the off-state and the current running state, the second target scheduling strategy of the virtual CPU.

In practical applications, before determining the scheduling strategy, the kernel scheduler can determine the current running state of the virtual CPU running in the run queue of the target physical CPU. In this embodiment, in case of determining that the quantity of the virtual CPUs is multiple, the current running state of each virtual CPU needs to be determined. Furthermore, the second target scheduling strategy corresponding to the virtual CPU is determined according to the off-state of the non-exit function of the virtual CPU and the current running states of the multiple virtual CPUs, in order to perform scheduling processing on the computing resource(s) of the physical CPU occupied by the virtual CPU according to the second target scheduling strategy.

According to the resource scheduling method provided by the embodiment of the present specification, by virtue of determination of the current running state of the virtual CPU in the run queue of the target physical CPU, and determination of the second target scheduling strategy of the virtual CPU according to the on-state of the virtual CPU, unnecessary waste of resources caused by unnecessary competition due to seizing of the time of the physical CPU by the multiple virtual CPUs is avoided.
Step 106: regulating, based on the target scheduling strategy, a running state of the virtual CPU of the virtual machine.

In practical applications, after the kernel scheduler determines different target scheduling strategies, the running state(s) of the virtual CPU(s) on each virtual machine can be regulated based on the target scheduling strategy, e.g., enabling the non-exit function of the virtual CPU, disabling the non-exit function of the virtual CPU, and other operations.

Specifically, in the resource scheduling method provided by the embodiment of the present specification, the first target scheduling strategy is a non-exit function strategy, the corresponding achieved effects are that the virtual CPU can perform the non-exit function, and this virtual CPU can monopolize the computing resource(s) of the physical CPU.

Correspondingly, the regulating, based on the target scheduling strategy, the running state of the virtual CPU includes:
regulating, based on the non-exit function strategy, the running state of the virtual CPU of the virtual machine.

In practical applications, the kernel scheduler can further regulate the running state of the virtual CPU in the virtual machine according to the non-exit function strategy, thereby achieving the non-exit function of the virtual CPU, so that the virtual CPU can monopolize the physical CPU resource(s), still does not exit when receiving an exit instruction and can enter into a dormant state, in order to improve the performance of the virtual CPU.

It should be noted that, in the resource scheduling method provided by the embodiment of the present specification, multiple ways can be used for regulating the running state of the virtual CPU based on different scheduling strategies, which is not limit specifically.

According to the resource scheduling method provided by the embodiment of the present specification, by dynamically regulating the running state of the virtual CPU of the virtual machine via the non-exit function strategy, the HLT non-exit function is applied in virtualized shared scenarios, so that the performance of the virtual CPU is improved due to the non-exit function.

In a specific implementation, the kernel scheduler also needs to determine a corresponding regulating manner for the non-exit function strategy determined by the current running state of the virtual CPU. Specifically, the regulating, based on the non-exit function strategy, the running state of the virtual CPU of the virtual machine includes:
in case of determining that the current running state is a non-exit function state, remaining, based on the non-exit function strategy, the current running state of the virtual CPU of the virtual machine; or
in case of determining that the current running state is an exit function state, enabling, based on the non-exit function strategy, the non-exit function of the virtual CPU of the virtual machine, and switching, based on the non-exit function of the virtual CPU, the running state of the virtual CPU to a non-exit function state.

In practical applications, the non-exit function strategy is aimed at keeping the virtual CPU in a state where the-non exit function is enabled, that is, after receiving an exit instruction, it can still remain in a dormant state without exiting; so the kernel scheduler needs to first determine the current running state of the virtual CPU running in the run queue of the physical CPU. In case of determining that the current running state is the non-exit function state, it indicates that the switch for the non-exit function of the virtual CPU has been enabled. Then, the kernel scheduler does not perform any processing operations on the virtual CPU, to keep the virtual CPU in the current state, thus the performance improvement of the virtual CPU can be achieved.

In addition, in case that the kernel scheduler determines the current running state is the exit function state, it indicates that the non-exit function of the virtual CPU is disabled. Then, the kernel scheduler can modify the switch state of the non-exit function of the virtual CPU to the on-state according to the non-exit function strategy. Specifically, the kernel scheduler can inform the monitoring layer of the virtual machine to modify the VMCS of the virtual CPU, to enable the CPU_BASED_HLT_EXITING bit, so that the virtual CPU is switched from the exit function state to the non-exit function state.

It should be noted that, all the scheduling operations of the kernel scheduler for the running state of the virtual CPU, can achieve the performance improvement of the virtual CPU according to the non-exit function under the circumstance that the virtual CPU monopolizes the physical CPU.

According to the resource scheduling method provided by the embodiment of the present specification, by determining the current running state of the virtual CPU, different functions to switch the non-exit function of the virtual CPU can be further executed, the running state of the virtual CPU is changed, thereby effectively improving the performance of the exclusive virtual CPU.

In addition, in the resource scheduling method provided by the embodiment of the present specification, the second target scheduling strategy is an exit function strategy, the corresponding achieved effects are making the non-exit function of the virtual CPU disabled, so the exit function of the virtual CPU is executed when the exit instruction is received.

Correspondingly, the regulating, based on the target scheduling strategy, the running state of the virtual CPU of the virtual machine includes:
regulating, based on the exit function strategy, the running state of the virtual CPU of the virtual machine.

In practical applications, the kernel scheduler can further regulate the running state of the virtual CPU in the virtual machine according to the exit function strategy, in order to achieve that the non-exit function of the virtual CPU is in the off-state, so that the virtual machine performs the exit function normally when receiving the exit instruction.

According to the resource scheduling method provided by the embodiment of the present specification, the running state of the virtual CPU of the virtual machine is regulated based on the exit function strategy, thereby achieving timely shutdown of the non-exit function of the virtual CPU when finding that the virtual CPU participates in unnecessary preemption of physical CPU resources, ensuring that unnecessary physical CPU resources are not consumed.

In a specific implementation, the kernel scheduler also needs to determine a corresponding regulating manner for the exit function strategy determined by the current running state of the virtual CPU. Specifically, the regulating, based on the exit function strategy, the running state of the virtual CPU of the virtual machine includes:
in case of determining that the current running state is a non-exit function state, disabling, based on the exit function strategy, the non-exit function of the virtual CPU of the virtual machine, and switching, based on the non-exit function of the virtual CPU, the running state of the virtual CPU to an exit function state; or
in case of determining that the current running state is an exit function state, remaining, based on the exit function strategy, the current running state of the virtual CPU of the virtual machine.

In practical applications, the exit function strategy is aimed at making the virtual CPU execute the exit operation normally when receiving the exit instruction; so the kernel scheduler can disable the non-exit function of the virtual CPU according to the exit function strategy in case of determining that the current running state of the virtual CPU is the non-exit function state. So that the virtual CPU is switched from the non-exit function state to the exit function state. Specifically, the kernel scheduler informs the monitoring layer of the virtual machine to modify the VMCS of the virtual CPU, to enable the CPU_BASED_HLT_EXITING bit, and to switch the virtual CPU to HLT exit.

In addition, in case of determining that the current running state of the virtual CPU is the exit function state, the kernel scheduler does not perform any processing on the virtual CPU, to keep the virtual CPU in the current state, which can ensure that non-exclusive virtual CPU does not consume unnecessary physical CPU resource(s), since the non-exit function is disabled.

According to the resource scheduling method provided by the embodiment of the present specification, when multiple virtual CPUs compete for resources on a same physical CPU, the non-exit function of the virtual CPU needs to be remained in the off-state, thereby preventing unnecessary competition caused by the virtual CPU from affecting the resource application effects in shared scenarios where the quantity of the virtual CPUs is greater than the quantity of the physical CPUs.

In summary, according to the resource scheduling method provided by the embodiment of the present specification, based on a scheduling system and a technology of HLT non-exit, achieving a scheduling strategy for a virtual CPU with dynamic HLT exit. When the HLT of the virtual machine is dynamically switched to exit or not exit according to whether the virtual CPU monopolizes the underlying physical CPU resource(s), and when it is detected that the virtual CPU monopolizes the physical CPU, its HLT non-exit function is enabled, to get performance improvement; when it is detected that the virtual CPU does not monopolize the physical CPU, its HLT non-exit function is disabled. This solution can effectively improve the performance of exclusive virtual CPUs in shared scenarios, and ensure that non-exclusive virtual CPUs do not consume unnecessary physical CPU resources.

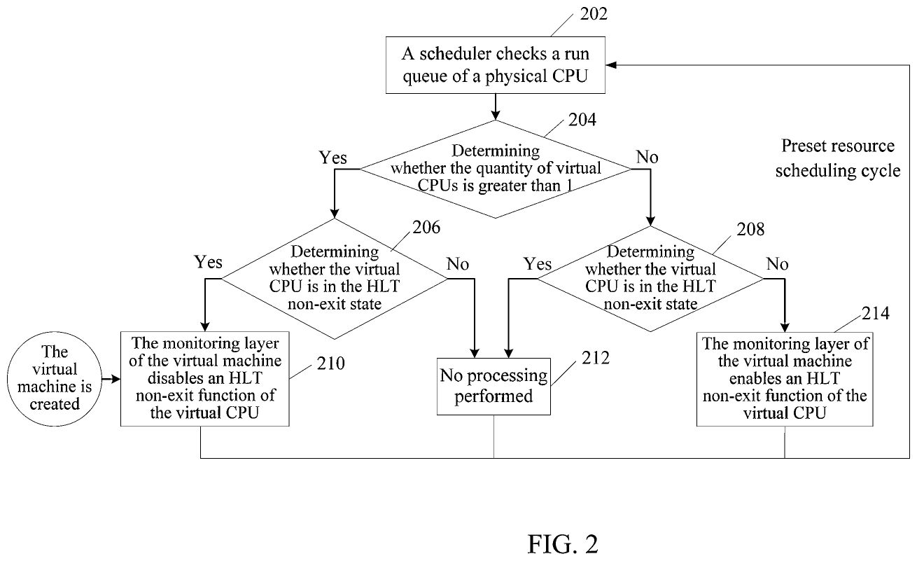

In the following, an example is taken where the resource scheduling method provided in the present specification is applied in a virtual CPU, for further explaining the resource scheduling method in combination with FIG. 2. FIG. 2 shows a schematic diagram of a processing procedure of a resource scheduling method provided in an embodiment of the present specification.
Step 202: a scheduler checks a run queue of a physical CPU.
Step 204: the scheduler determines whether the quantity of virtual CPUs in the run queue of the physical CPU is greater than 1; if so, execute step 206; or else, execute step 208.
Step 206: the scheduler determines whether a virtual CPU is in an HLT non-exit state; if so, execute step 210; or else, execute step 212.
Step 208: the scheduler determines whether a virtual CPU is in an HLT non-exit state; if so, execute step 212; or else, execute step 214.
Step 210: a monitoring layer of a virtual machine disables an HLT non-exit function of the virtual CPU.
Step 212: the scheduler does not perform any processing.
Step 214: the monitoring layer of the virtual machine enables an HLT non-exit function of the virtual CPU.

It should be noted that after step 210, step 212 and step 214 are completed, and after each preset scheduling cycle, the scheduler can continue to execute step 202; and FIG. 2 also illustrates that when the virtual machine is created, the initialization state set by the monitoring layer of the virtual machine is to disable the HLT non-exit function of the virtual CPU.

In practical applications, the specific execution steps can be referred to as follows, step 1: the monitoring layer of the virtual machine performs initialization, exposes functional interfaces that can query and dynamically regulate HLT non-exit to the kernel scheduler; step 2: virtualized initialization. When the virtual machine is first created, the monitoring layer of the virtual machine ensures that the newly enabled HLT non-exit function of the virtual machine remains in the off-state by setting the CPU-BASED-HLT-EXITING bit of the VMCS; step 3: the scheduler dynamically regulates the HLT non-exit state. When the scheduler chooses, for the physical CPU, one virtual CPU for running, it reads the run queue of the physical CPU, checks whether there is only one virtual CPU on the physical CPU; step 3.1: when there is only one virtual CPU on the physical CPU, it checks the HLT non-exit state of the virtual CPU via the interfaces provided by the monitoring layer of the virtual machine; step 3.1.1: when the virtual CPU is in HLT non-exit, remain in the current state; step 3.1.2: when the virtual CPU is in HLT exit, the scheduler informs the monitoring layer of the virtual machine to modify the VMCS of the virtual CPU, to disable the CPU_BASED_HLT_EXITING bit, then the virtual CPU is switched to the HLT non-exit; step 3.2: when there are multiple virtual CPUs on the physical CPU, it checks the HLT non-exit state of the virtual CPU still via the interfaces provided by the monitoring layer of the virtual machine; step 3.2.1: when the virtual CPU is in HLT exit, remain in the current state; step 3.2.2: when the virtual CPU is in HLT non-exit, the scheduler informs the monitoring layer of the virtual machine to modify the VMCS of the virtual CPU, to enable the CPU_BASED_HLT_EXITING bit, then the virtual CPU is switched to the HLT exit.

According to the resource scheduling method provided by the embodiment of the present specification, dynamic enabling-disabling of HLT non-exit function is achieved in the monitoring layer of the virtual machine; and by implementing a strategy in the scheduler to monitor in real-time whether there is virtual CPU(s) competing on the physical CPU, the monitoring layer of the virtual machine is informed to dynamically enable or disable the HLT non-exit function. Based on this technology, the HLT non-exit function is applied to virtualized sharing scenarios, allowing the shared virtual machine to enjoy the performance improvement brought by HLT non-exit technology. At the same time, based on the dynamical regulating strategy, the HLT non-exit function can also be timely disabled when there is competition between virtual CPUs, ensuring that unnecessary physical CPU resources are not consumed.

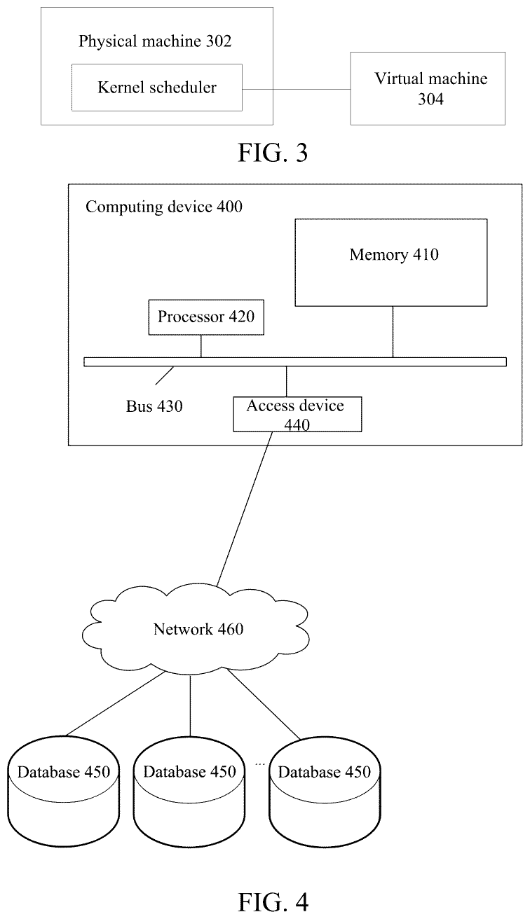

Corresponding to the above method embodiments, the present specification also provides an embodiment of a resource scheduling apparatus. FIG. 3 shows a schematic structural diagram of a resource scheduling apparatus provided in an embodiment of the present specification. As shown in FIG. 3, the apparatus is applied to a physical machine 302, and includes:
a kernel scheduler of the physical machine 302, configured to determine, based on a preset resource scheduling cycle, a quantity of virtual CPUs of a virtual machine 304 running in a run queue of a target physical CPU;
where the kernel scheduler of the physical machine 302 is further configured to determine, based on the quantity of the virtual CPUs, a switch state of a non-exit function of a virtual CPU, and determine, based on the switch state, a target scheduling strategy of the virtual CPU;
the kernel scheduler of the physical machine 302 is further configured to regulate, based on the target scheduling strategy, a running state of the virtual CPU of the virtual machine 304.

Optionally, the kernel scheduler of the physical machine 302 is further configured to:
in case of determining that the quantity of the virtual CPUs running in the run queue is less than or equal to 1, determine that the switch state of the non-exit function of the virtual CPU is an on-state.

Optionally, the kernel scheduler of the physical machine 302 is further configured to:
determine a current running state of the virtual CPU, and determine, based on the on-state and the current running state, a first target scheduling strategy of the virtual CPU.

Optionally, the first target scheduling strategy is a non-exit function strategy.

Optionally, the kernel scheduler of the physical machine 302 is further configured to:
regulate, based on the non-exit function strategy, the running state of the virtual CPU of the virtual machine.

Optionally, the kernel scheduler of the physical machine 302 is further configured to:
in case of determining that the current running state is a non-exit function state, remain, based on the non-exit function strategy, the current running state of the virtual CPU of the virtual machine; or
in case of determining that the current running state is an exit function state, enable, based on the non-exit function strategy, the non-exit function of the virtual CPU of the virtual machine, and switch, based on the non-exit function of the virtual CPU, the running state of the virtual CPU to a non-exit function state.

Optionally, the kernel scheduler of the physical machine 302 is further configured to:
in case of determining that the quantity of the virtual CPUs running in the run queue is greater than 1, determine that the switch state of the non-exit function of the virtual CPU is an off-state.

Optionally, the kernel scheduler of the physical machine 302 is further configured to:
determine a current running state of the virtual CPU, and determine, based on the off-state and the current running state, a second target scheduling strategy of the virtual CPU.

Optionally, the second target scheduling strategy is an exit function strategy.

Optionally, the kernel scheduler of the physical machine 302 is further configured to:
regulate, based on the exit function strategy, the running state of the virtual CPU of the virtual machine.

Optionally, the kernel scheduler of the physical machine 302 is further configured to:
in case of determining that the current running state is a non-exit function state, disable, based on the exit function strategy, the non-exit function of the virtual CPU of the virtual machine, and switch, based on the non-exit function of the virtual CPU, the running state of the virtual CPU to an exit function state; or
in case of determining that the current running state is an exit function state, remain, based on the exit function strategy, the current running state of the virtual CPU of the virtual machine.

Optionally, the kernel scheduler of the physical machine 302 is further configured to:
schedule, by the kernel scheduler of the physical machine, a scheduling interface for the virtual CPU sent by a monitoring layer in the virtual machine, where the scheduling interface is an interface for forwarding a regulating parameter of the running state of the virtual CPU of the virtual machine.

According to the resource scheduling apparatus provided by the embodiment of the present specification, the kernel scheduler of the physical machine determines, based on the quantity of virtual CPUs of the virtual machine running in the run queue of the target physical CPU, whether the non-exit function(s) of the virtual CPU(s) is/are enabled; and then determines, according to a state of whether the non-exit function(s) is/are enabled, the target scheduling strategy corresponding to the virtual CPU(s), to regulate the running state(s) of the virtual CPU(s); and dynamically regulates, according to the target scheduling strategy, the non-exit function(s) of the virtual CPU(s), thereby achieving timely shutdown of the non-exit function(s) of the virtual CPU(s), ensuring that unnecessary physical CPU resources are not consumed, as well as enabling the non-exit function(s) of the virtual CPU(s) to improve application performance of the virtual CPU(s).

The above description is a schematic solution of the resource scheduling apparatus of the present embodiment. It should be noted that the technical solution of the resource scheduling apparatus belongs to the same concept as the technical solution of the resource scheduling method mentioned above. Any details not described in detail in the technical solution of the resource scheduling apparatus can be found in the description of the technical solution of the resource scheduling method mentioned above.

FIG. 4 shows a block diagram of a structure of a computing device 400 provided in an embodiment of the present specification. Components of the computing device 400 include, but not limited to, a memory 410 and a processor 420. The processor 840 and the memory 410 are connected with each other through a bus 430. A database 450 is configured to store data.

The computing device 400 also includes an access device 440, the access device 440 enables the computing device 400 to communicate through one or more networks 460. Examples of these networks include public switched telephone networks (PSTN), local area networks (LAN), wide area networks (WAN), personal area networks (PAN), or a combination of communication networks such as the Internet. The access device 440 may include one or more of any type of wired or wireless network interfaces (such as a network interface card (NIC)), such as IEEE802.11 wireless local area network (WLAN) wireless interface, worldwide interoperability for microwave access (Wi-MAX) interface, Ethernet interface, universal serial bus (USB) interface, cellular network interface, Bluetooth interface, near field communication (NFC) interface, and so on.

In an embodiment of the present specification, the aforementioned components of the computing device 400 and other components not shown in FIG. 4 may also be connected to each other, for example, through the bus. It should be understood that the block diagram of the structure of the computing device shown in FIG. 4 is only for illustrative purposes rather than a limitation on the scope of the present specification. Those skilled in the art can add or replace other components as needed.

The computing device 400 can be any type of stationary or mobile computing device, including a mobile computer or mobile computing device (such as a tablet computer, a personal digital assistant, a laptop computer, a notebook computer, a netbook, etc.), a mobile phone (such as a smartphone), a wearable computing device (such as a smart watch, smart glasses, etc.), or other types of mobile devices, or a static computing device such as a desktop computer or PC. The computing device 400 may also be a mobile or stationary server.

The processor 420 is configured to execute the following computer executable instructions, when the computer executable instructions are executed by the processor, steps of the resource scheduling methods mentioned above are implemented.

The above descriptions are schematic solutions of the computing device of this embodiment. It should be noted that the technical solution of the computing device belongs to the same concept as the technical solution of the resource scheduling methods mentioned above, any details not described in detail in the technical solution of the computing device can be found in the description of the technical solution of the resource scheduling methods mentioned above.

An embodiment of the present specification further provides a computer readable storage medium, where the computer readable storage medium stores computer executable instructions, when the computer executable instructions are executed by a processor, steps of the resource scheduling methods mentioned above are implemented.

The above description is a schematic solution of a computer readable storage medium of this embodiment. It should be noted that the technical solution of the storage medium belongs to the same concept as the technical solution of the resource scheduling methods mentioned above, any details not described in detail in the technical solution of the storage medium can be found in the description of the technical solution of the resource scheduling methods mentioned above.

An embodiment of the present specification further provides a computer program, where when the computer program is executed in a computer, the computer is enabled to execute steps of the resource scheduling methods mentioned above.

The above description is a schematic solution of a computer program of this embodiment. It should be noted that the technical solution of the computer program belongs to the same concept as the technical solution of the resource scheduling methods mentioned above, any details not described in detail in the technical solution of the computer program can be found in the description of the technical solution of the resource scheduling methods mentioned above.

Description is made above to specific embodiments of the present specification. Other embodiments are within the scope of the appended claims. In some cases, actions or steps recorded in the claims may be executed in an order different from that in the embodiments and still achieve the desired results. In addition, the process depicted in the drawings does not necessarily require a specific or continuous order to achieve the desired results. In some implementations, multitasking processing and parallel processing are also possible or may be advantageous.

The computer instructions include computer program codes, the computer program codes may be in the form of source codes, object codes, executable files, or in some intermediate forms. The computer readable medium may include: any entity or apparatus capable of carrying the computer program codes, recording medium, USB flash drive, portable hard drive, magnetic disc, optical disc, computer memory; read-only memory (ROM, Read-Only Memory), random access memory (RAM, Random Access Memory), electrical carrier signal, telecommunication signal, and software distribution medium, etc. It should be noted that content contained in the computer readable medium can be appropriately added or cut according to the requirements of legislation and patent practice in the jurisdiction. For example, in some jurisdictions, according to the legislation and patent practice, the computer readable medium does not include electric carrier signals and telecommunication signals.

It should be noted that for the convenience of description, the aforementioned embodiments of each method are all expressed as a series of action combinations. However, those skilled in the art should be aware that the embodiments of the present specification are not limited by the described order of actions, as according to the embodiments of the present specification, certain steps can be performed in other orders or simultaneously. Secondly, order should also be aware that the embodiments described in the specification are all preferred embodiments, and the actions and modules involved may not necessarily be necessary for the embodiments in the present specification.

In the embodiments mentioned above, the description of respective embodiment has its own emphasis. For parts without detailed description in one embodiment, reference can be made to the relevant descriptions of other embodiments.

The preferred embodiments of the present specification disclosed above are only intended to assist in elaborating the present specification. The optional embodiments do not fully describe all the details, nor do they limit the invention to only the specific implementations described. Obviously, according to the content of the embodiments in the present specification, various modifications and changes can be made. The present specification selects and specifically describes these embodiments in order to better explain the principles and practical applications of the embodiments in the present specification, so that those skilled in the art can understand and utilize the present specification well. The present specification is limited only by the claims and their entire scope and equivalents.

1. A resource scheduling method, applied to a physical machine and comprising:
determining, by a kernel scheduler of the physical machine, based on a preset resource scheduling cycle, a quantity of virtual CPUs of a virtual machine running in a run queue of a target physical CPU;
determining, based on the quantity of the virtual CPUs, a switch state of a non-exit function of a virtual CPU, and determining, based on the switch state, a target scheduling strategy of the virtual CPU;
regulating, based on the target scheduling strategy, a running state of the virtual CPU of the virtual machine.

2. The resource scheduling method according to claim 1, wherein the determining, based on the quantity of the virtual CPUs, the switch state of the non-exit function of the virtual CPU comprises:
in case of determining that the quantity of the virtual CPUs running in the run queue is less than or equal to 1, determining that the switch state of the non-exit function of the virtual CPU is an on-state.

3. The resource scheduling method according to claim 2, wherein the determining, based on the switch state, the target scheduling strategy of the virtual CPU comprises:
determining a current running state of the virtual CPU, and determining, based on the on-state and the current running state, a first target scheduling strategy of the virtual CPU.

4. The resource scheduling method according to claim 3, wherein the first target scheduling strategy is a non-exit function strategy;
correspondingly, the regulating, based on the target scheduling strategy, the running state of the virtual CPU comprises:
regulating, based on the non-exit function strategy, the running state of the virtual CPU of the virtual machine.

5. The resource scheduling method according to claim 4, wherein the regulating, based on the non-exit function strategy, the running state of the virtual CPU of the virtual machine comprises:
in case of determining that the current running state is a non-exit function state, remaining, based on the non-exit function strategy, the current running state of the virtual CPU of the virtual machine; or
in case of determining that the current running state is an exit function state, enabling, based on the non-exit function strategy, the non-exit function of the virtual CPU of the virtual machine, and switching, based on the non-exit function of the virtual CPU, the running state of the virtual CPU to a non-exit function state.

6. The resource scheduling method according to claim 1, wherein the determining, based on the quantity of the virtual CPUs, the switch state of the non-exit function of the virtual CPU comprises:
in case of determining that the quantity of the virtual CPUs running in the run queue is greater than 1, determining that the switch state of the non-exit function of the virtual CPU is an off-state.

7. The resource scheduling method according to claim 6, wherein the determining, based on the switch state, the target scheduling strategy of the virtual CPU comprises:
determining a current running state of the virtual CPU, and determining, based on the off-state and the current running state, a second target scheduling strategy of the virtual CPU.

8. The resource scheduling method according to claim 7, wherein the second target scheduling strategy is an exit function strategy;
correspondingly, the regulating, based on the target scheduling strategy, the running state of the virtual CPU of the virtual machine comprises:
regulating, based on the exit function strategy, the running state of the virtual CPU of the virtual machine.

9. The resource scheduling method according to claim 8, wherein the regulating, based on the exit function strategy, the running state of the virtual CPU of the virtual machine comprises:
in case of determining that the current running state is a non-exit function state, disabling, based on the exit function strategy, the non-exit function of the virtual CPU of the virtual machine, and switching, based on the non-exit function of the virtual CPU, the running state of the virtual CPU to an exit function state; or
in case of determining that the current running state is an exit function state, remaining, based on the exit function strategy, the current running state of the virtual CPU of the virtual machine.

10. The resource scheduling method according to claim 1, before the determining, by the kernel scheduler of the physical machine, based on the preset resource scheduling cycle, the quantity of the virtual CPUs running in the run queue of the target physical CPU, further comprising:
scheduling, by the kernel scheduler of the physical machine, a scheduling interface for the virtual CPU sent by a monitoring layer in the virtual machine, wherein the scheduling interface is an interface for forwarding a regulating parameter of the running state of the virtual CPU of the virtual machine.

11. A resource scheduling apparatus, applied to a physical machine and comprising:
a kernel scheduler of the physical machine, configured to determine, based on a preset resource scheduling cycle, a quantity of virtual CPUs of a virtual machine running in a run queue of a target physical CPU;
wherein the kernel scheduler of the physical machine is further configured to determine, based on the quantity of the virtual CPUs, a switch state of a non-exit function of a virtual CPU, and determine, based on the switch state, a target scheduling strategy of the virtual CPU;
wherein the kernel scheduler of the physical machine is further configured to regulate, based on the target scheduling strategy, a running state of the virtual CPU of the virtual machine.

12. A computing device, comprising:
a memory and a processor;
wherein the memory is configured to store computer executable instructions, the processor is configured to execute the computer executable instructions, when the computer executable instructions are executed by the processor, following steps are implemented:
determining, by a kernel scheduler of the physical machine, based on a preset resource scheduling cycle, a quantity of virtual CPUs of a virtual machine running in a run queue of a target physical CPU;
determining, based on the quantity of the virtual CPUs, a switch state of a non-exit function of a virtual CPU, and determining, based on the switch state, a target scheduling strategy of the virtual CPU;
regulating, based on the target scheduling strategy, a running state of the virtual CPU of the virtual machine.

13. A non-transitory computer readable storage medium, storing computer executable instructions, when the computer executable instructions are executed by a processor, steps of the resource scheduling method according to claim 1 are implemented.

14. The resource scheduling apparatus according to claim 11, wherein the kernel scheduler of the physical machine is further configured to:
in case of determining that the quantity of the virtual CPUs running in the run queue is less than or equal to 1, determine that the switch state of the non-exit function of the virtual CPU is an on-state.

15. The resource scheduling apparatus according to claim 14, wherein the kernel scheduler of the physical machine is further configured to:
determine a current running state of the virtual CPU, and determine, based on the on-state and the current running state, a first target scheduling strategy of the virtual CPU.

16. The resource scheduling apparatus according to claim 15, wherein the first target scheduling strategy is a non-exit function strategy;
the kernel scheduler of the physical machine is further configured to:
regulate, based on the non-exit function strategy, the running state of the virtual CPU of the virtual machine.

17. The resource scheduling apparatus according to claim 11, wherein the kernel scheduler of the physical machine is further configured to:
in case of determining that the quantity of the virtual CPUs running in the run queue is greater than 1, determine that the switch state of the non-exit function of the virtual CPU is an off-state.

18. The resource scheduling apparatus according to claim 17, wherein the kernel scheduler of the physical machine is further configured to:
determine a current running state of the virtual CPU, and determine, based on the off-state and the current running state, a second target scheduling strategy of the virtual CPU.

19. The resource scheduling apparatus according to claim 18, wherein the second target scheduling strategy is an exit function strategy;
the kernel scheduler of the physical machine is further configured to:
regulate, based on the exit function strategy, the running state of the virtual CPU of the virtual machine.

20. The resource scheduling apparatus according to claim 11, wherein the kernel scheduler of the physical machine is further configured to:
schedule, by the kernel scheduler of the physical machine, a scheduling interface for the virtual CPU sent by a monitoring layer in the virtual machine, wherein the scheduling interface is an interface for forwarding a regulating parameter of the running state of the virtual CPU of the virtual machine.
